(19) United States
(12) Patent Application Publication
(10) Pub. No.: US 2026/0251490 A1
(43) Pub. Date: Aug. 27, 2026

(54) REMAINING GAS AMOUNT MANAGEMENT SYSTEM

(71) Applicant: PANASONIC INTELLECTUAL PROPERTY MANAGEMENT CO., LTD., Osaka (JP)

(72) Inventors: Masumi YAMASHITA, Nara (JP); Takashi WATANABE, Nara (JP); Tadanori SHIRASAWA, Nara (JP); Kenichi WATANABE, Osaka (JP)

(21) Appl. No.: 19/489,688

(22) PCT Filed: May 28, 2024
(86) PCT No.: PCT/JP2024/019550

§ 371 Date: Dec. 3, 2025

(30) Foreign Application Priority Data
Jun. 6, 2023 (JP) 2023-093329

(51) Int. Cl. G01F 22/02

(52) U.S. Cl. CPC G01F 22/02

(57) ABSTRACT

A remaining gas amount management system includes: a flow rate measurer that measures a flow rate of a gas flowing to a gas appliance from a gas container located at a consumer's place or at each of a plurality of consumer's places; a remaining amount calculator that calculates a predicted value by using past data indicating past gas consumption in a first predetermined period, the predicted value representing a remaining gas amount of the gas container after a second predetermined period has elapsed; and an informer that informs of a replacement timing of the gas container based on the predicted value or a replacement cycle of the gas container. Based on predetermined prediction frequency change trigger information, the remaining amount calculator changes a frequency at which the predicted value is calculated.

### TECHNICAL FIELD

The present invention relates to a remaining gas amount management system that manages remaining gas amounts of respective consumer's places.

### BACKGROUND ART

Conventionally known is a gas run-out estimation system that specifies an estimated gas run-out date by grasping a remaining gas amount by high-frequency measurement from a gas meter that detects the flow rate of a used gas flowing to a gas appliance from a gas container located at a consumer's place (PTL 1).

### CITATION LIST

### Patent Literature

PTL 1: Japanese Laid-Open Patent Application Publication No. 2019-124285

### SUMMARY OF INVENTION

### Technical Problem

By predicting the remaining gas amount based on data measured at a high frequency, the accuracy of the predicted value is improved. However, in order to enable the prediction at a high frequency, it is necessary to increase the specifications of a server, and as a result, the cost increases. Moreover, a processing time significantly increases due to the prediction at a high frequency. Furthermore, especially when performing the prediction using machine learning, the creation of input processing information for learning and the creation of a prediction model require enormous cost and processing time.

An object of the present invention is to provide a remaining gas amount management system that can suppress cost and processing time when predicting a remaining gas amount in a gas container at a consumer's place.

### Solution to Problem

A remaining gas amount management system of the present invention includes: a flow rate measurer that measures a flow rate of a gas flowing to a gas appliance from a gas container located at a consumer's place or at each of a plurality of consumer's places; a remaining amount calculator that calculates a predicted value by using past data indicating past gas consumption in a first predetermined period, the predicted value representing a remaining gas amount of the gas container after a second predetermined period has elapsed; and an informer that informs of a replacement timing of the gas container based on the predicted value or a replacement cycle of the gas container, wherein based on predetermined prediction frequency change trigger information, the remaining amount calculator changes a frequency at which the predicted value is calculated.

According to the present invention, based on the predetermined prediction frequency change trigger information, the remaining amount calculator changes the frequency at which the predicted value of the remaining gas amount is calculated. In this case, during a fixed period, the remaining amount calculator calculates the predicted value at a predetermined frequency. After the fixed period has elapsed, the remaining amount calculator calculates the predicted value at a frequency higher than the predetermined frequency. For example, during the fixed period, the remaining amount calculator may calculate the predicted value once every three days. After the fixed period has elapsed, the remaining amount calculator may calculate the predicted value once a day. As above, according to the present invention, although the remaining amount calculator calculates the predicted value at a high frequency after the fixed period has elapsed, the remaining amount calculator does not calculate the predicted value at a high frequency before the fixed period elapses. Therefore, the load on the server can be reduced compared to before. Thus, the processing time can be prevented from increasing, and the necessity of increasing the specifications of the server can be reduced. Therefore, the cost and the processing time when predicting the remaining gas amount in the gas container at the consumer's place can be suppressed.

In the above invention, the remaining amount calculator may change the frequency based on a past actual value of the replacement cycle as the prediction frequency change trigger information.

According to the above configuration, when using the replacement timing as the prediction frequency change trigger information, for example, the remaining amount calculator can calculate the predicted value once every three days until the number of days corresponding to half the replacement cycle elapses after the replacement cycle is informed, and calculate the predicted value once a day after the number of days elapsed has exceeded half the replacement cycle. Thus, the load on the server can be reduced. Therefore, the cost and the processing time when predicting the remaining gas amount can be suppressed.

In the above invention, the remaining amount calculator may change the frequency based on an elapsed time since the replacement of the gas container, as the prediction frequency change trigger information.

According to the above configuration, when using the elapsed time since the replacement of the gas container as the prediction frequency change trigger information, for example, the remaining amount calculator can calculate the predicted value once every three days during the fixed period from immediately after the replacement, and calculate the predicted value once every two days after the fixed period has elapsed. Thus, the load on the server can be reduced. Therefore, the cost and the processing time when predicting the remaining gas amount can be suppressed.

In the above invention, when the replacement cycle as the prediction frequency change trigger information is a first threshold or more, the remaining amount calculator may calculate the predicted value, and when the replacement cycle is less than the first threshold, the remaining amount calculator may not calculate the predicted value.

According to the above configuration, the remaining amount calculator can be configured not to calculate the predicted value of the remaining gas amount for the consumer's place whose replacement cycle is less than the first threshold. In this case, when the replacement cycle is short and constant, the necessity of calculating the predicted value is low. Therefore, the processing of calculating the predicted value can be reduced.

In the above invention, the remaining amount calculator may change the frequency based on the remaining gas amount obtained from the gas consumption, as the prediction frequency change trigger information.

According to the above configuration, when using the remaining gas amount as the prediction frequency change trigger information, for example, the remaining amount calculator can calculate the predicted value once every seven days when the remaining gas amount is 50% or more of the volume of the gas container, and calculate the predicted value once every two days when the remaining gas amount is less than 50% of the volume of the gas container. Thus, the load on the server can be reduced. Therefore, the cost and the processing time when predicting the remaining gas amount can be suppressed.

In the above invention, when the remaining gas amount is less than a second threshold, the remaining amount calculator may calculate the predicted value.

According to the above configuration, the remaining amount calculator can be configured not to calculate the predicted value of the remaining gas amount when the remaining gas amount is the second threshold or more. Thus, the processing of calculating the predicted value can be reduced.

In the above invention, when the remaining gas amount is a third threshold or more, the remaining amount calculator may set the frequency to be lower than the frequency set when the remaining gas amount is less than the third threshold.

According to the above configuration, since the frequency at which the predicted value is calculated can be relatively lowered when the remaining gas amount is the third threshold or more, the processing of calculating the predicted value can be reduced.

In the above invention, the remaining amount calculator may change the frequency based on informing performed by the informer, as the prediction frequency change trigger information.

According to the above configuration, when using the informing performed by the informer as the prediction frequency change trigger information, for example, the remaining amount calculator can calculate the predicted value once every two days before the informing is performed, and calculate the predicted value once a day after the informing has been performed. Thus, the load on the server can be reduced. Therefore, the cost and the processing time when predicting the remaining gas amount can be suppressed.

In the above invention, after the remaining amount calculator calculates the predicted value, the remaining amount calculator may compare the predicted value as the prediction frequency change trigger information with a fourth threshold, and when the predicted value is the fourth threshold or more, the remaining amount calculator may set the frequency to be lower than the frequency set when the predicted value is less than the fourth threshold.

According to the above configuration, for example, the remaining amount calculator calculates the predicted value of the remaining gas amount when a predetermined number of days has elapsed since the replacement of the gas container. Then, when the predicted value is the fourth threshold or more, the frequency at which the predicted value is calculated is lowered thereafter. Thus, the processing of calculating the predicted value can be reduced.

In the above invention, after the remaining amount calculator calculates the predicted value, the remaining amount calculator may calculate, based on the predicted value, the number of days available until a replacement timing of the gas container; the remaining amount calculator may compare the number of days available as the prediction frequency change trigger information with a fifth threshold; and when the number of days available is the fifth threshold or more, the remaining amount calculator may set the frequency to be lower than the frequency set when the number of days available is less than the fifth threshold.

According to the above configuration, for example, the remaining amount calculator calculates the predicted value of the remaining gas amount when a predetermined number of days has elapsed since the replacement of the gas container. Then, when the number of days available is the fifth threshold or more, the frequency at which the predicted value is calculated is lowered thereafter. Thus, the processing of calculating the predicted value can be reduced.

In the above invention, after the remaining amount calculator calculates the predicted value, the remaining amount calculator may calculate a consumable amount based on a present remaining gas amount and the predicted value, the consumable amount being an amount of gas usable per day until the second predetermined period elapses; the remaining amount calculator may compare the gas consumption on or after the day following the day on which the consumable amount as the prediction frequency change trigger information is calculated, with the consumable amount; when the gas consumption exceeds the consumable amount, the remaining amount calculator may calculate the predicted value; and when the gas consumption is the consumable amount or less, the remaining amount calculator may not calculate the predicted value.

According to the above configuration, for example, the remaining amount calculator calculates the predicted value of the remaining gas amount when a predetermined number of days has elapsed since the replacement of the gas container. Then, when the gas consumption is the consumable amount or less, the remaining amount calculator does not calculate the predicted value thereafter. Thus, the processing of calculating the predicted value can be reduced.

### Advantageous Effects of Invention

The present invention can provide the remaining gas amount management system that can suppress the cost and the processing time when predicting the remaining gas amount in the gas container at the consumer's place.

### BRIEF DESCRIPTION OF DRAWINGS

FIG. 1 is a block diagram showing a remaining gas amount management system according to one embodiment.

FIG. 2 is a block diagram showing the configurations of a consumer's place and a center server in the remaining gas amount management system of FIG. 1.

FIG. 3 is a diagram for explaining a replacement cycle of a gas container.

FIG. 4 is a diagram showing one example of the replacement cycles in respective seasons.

FIG. 5 is a flowchart showing one example of the flow of steps performed by the remaining gas amount management system.

FIG. 6 is a diagram showing a time series regarding the management of the remaining gas amount of the consumer's place.

FIG. 7 is a diagram showing a time series regarding the management of the remaining gas amount according to Modified Example of FIG. 6.

FIG. 8 is a flowchart showing another example of the flow of steps performed by the remaining gas amount management system.

### DESCRIPTION OF EMBODIMENTS

Hereinafter, remaining gas amount management systems according to embodiments of the present invention will be described with reference to the drawings. Each remaining gas amount management system described below is merely one embodiment of the present invention. Therefore, the present invention is not limited to the following embodiments, and additions, deletions, and modifications may be made within the scope of the present invention.

### Embodiment 1

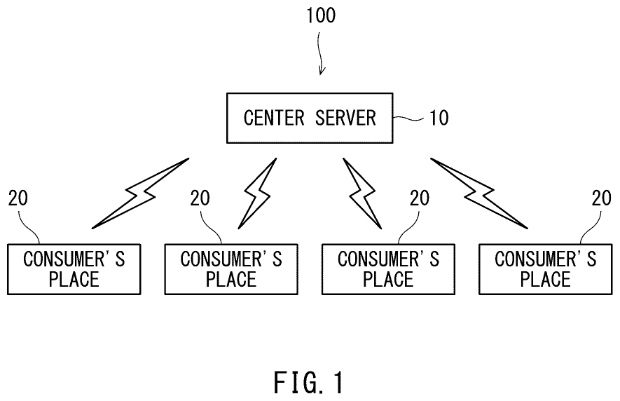

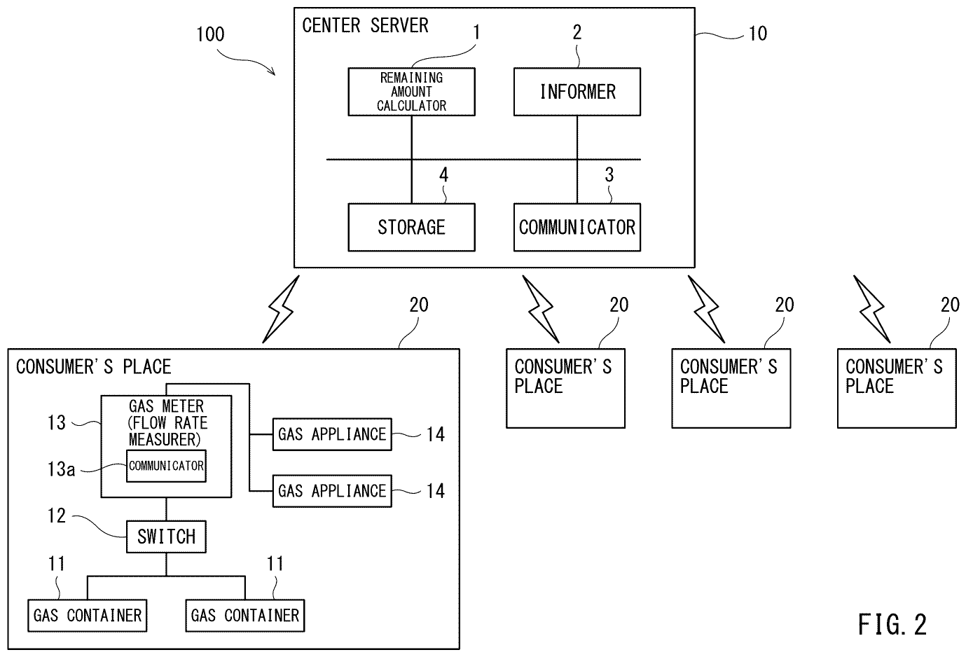

FIG. 1 is a block diagram showing a remaining gas amount management system 100 according to the present embodiment. FIG. 2 is a block diagram showing the detailed configurations of a consumer's place 20 and a center server 10 in the remaining gas amount management system 100 shown in FIG. 1.

As shown in FIG. 1, the remaining gas amount management system 100 includes the center server 10 and the consumer's places 20. FIG. 1 shows four consumer's places 20. However, in the remaining gas amount management system 100, the number of consumer's places 20 may be three or less or may be five or more.

As shown in FIG. 2, each consumer's place 20 includes two gas containers 11, a switch 12, a gas meter 13, and two gas appliances 14. The gas meter 13 corresponds to a flow rate measurer. Examples of the consumer's place 20 include a hospital, a school, a municipal facility, a nursing care facility, an ordinary home, and a commercial facility. However, the consumer's place is not limited to these and may be a building that may use gas.

The gas container 11 is also called a gas bomb and is filled with gas, such as LP gas (liquefied petroleum gas). Hereinafter, the LP gas is simply referred to as gas. The switch 12 switches a gas supply passage such that the gas in one of the two gas containers 11 is supplied to the consumer's place 20. Thus, even when the gas in one of the two gas containers 11 runs out, the gas in the other gas container 11 may be supplied to the gas appliance 14.

In the present embodiment, such gas run-out is defined as below. That the switch 12 switches the gas container 11 that is used means that the gas container 11 that has been used until this switching is in a gas run-out state. In this case, the switch 12 detects a change in pressure applied in the gas container 11 and switches the gas container 11. Specifically, the gas container 11 is filled with the gas under pressure. When the gas runs out, the pressure decreases. The switch 12 detects this pressure change and switches the gas container 11 at a timing at which the pressure has decreased to a predetermined value. Therefore, the decreasing of the pressure, detected by the switch 12, to the predetermined value can be regarded as the gas run-out. Moreover, the gas run-out includes a case where the gas container 11 is manually switched when the gas appliance 14 cannot be used due to the pressure decrease. Furthermore, the gas run-out includes a case where instead of the pressure, for example, a remaining amount obtained by subtracting a used gas amount from an assumed gas volume is zero or a value close to zero. These definitions are applied to the gas run-out of the two gas containers 11.

The gas meter 13 measures, for example, the flow rate of the gas flowing to the gas appliance 14 from the gas container 11 located at the consumer's place 20 and converts the flow rate into a reference value indicating information regarding the use amount (consumption) of the gas. When the gas meter 13 detects an abnormality, the gas meter 13 may execute a measure, such as blocking of the gas supply passage by a blocker.

The gas meter 13 includes a communicator 13a. The communicator 13a has a function of wirelessly communicating with a communicator 3 in the center server 10. A communication network, such as the Internet, a LAN, a LPWA (Low Power Wide Area), or WI-SUN, can be used as a wireless communication system between the communicator 13a and the communicator 3 of the center server 10. The communicator 13a periodically (once a day, for example) transmits information regarding the reference value indicating the information of the gas use amount (consumption) of the consumer's place 20 to the communicator 3 of the center server 10 together with date information regarding use or non-use (i.e., the use amount is zero), an ID that specifies the consumer's place 20, and location area information of the consumer's place 20. The communicator 13a does not have to be located in the gas meter 13 and may be located separately from the gas meter 13.

The gas appliance 14 is, for example, a gas stove, a gas water heater, a gas fan heater, or the like. However, the gas container 14 is not limited to these and may be equipment that consumes gas.

The center server 10 includes a remaining amount calculator 1, an informer 2, a communicator 3, and a storage 4. The remaining amount calculator 1 and the informer 2 among the above components of the center server 10 are functionally realized by: a microcontroller including a CPU (Central Processing Unit) and a memory (a ROM (Read Only Memory) and a RAM (Random Access Memory)) storing a program; an ASIC (Application Specific Integrated Circuit); or the like. Examples of the storage 4 include various memories and hard disks. The center server 10 may be configured by a cloud system.

The remaining amount calculator 1 periodically (once a day, for example) receives a measurement result of the gas use amount which is transmitted from the communicator 13a of the gas meter 13 of each consumer's place 20 through the communicator 3. The remaining amount calculator 1 calculates the present remaining gas amount of the gas container 11 from the measurement result based on gas container installation information given to each consumer's place 20. In this case, the remaining amount calculator 1 can obtain the remaining gas amount by subtracting the above use amount from an initial amount of gas in the gas container 11 which is prestored in the storage 4. The gas container installation information is information necessary when calculating the remaining gas amount based on the measurement result of the gas use amount by the gas meter 13, and is information indicating the number of consumer's places 20 associated with one gas container 11. In FIG. 2, the number of consumer's places 20 associated with one gas container 11 is one. Therefore, the gas container installation information indicates one. On the other hand, in the case of, for example, an apartment building including a plurality of consumer's places 20, the gas meters 13 are provided for the respective consumer's places 20, and the gas containers 11 are collected at one place. To be specific, the number of gas containers 11 associated with the consumer's places 20 is one. Therefore, for example, when the number of consumer's places 20 is four, the gas container installation information indicates four. The gas container installation information may include the number of gas containers 11 located upstream of the switch 12 in the consumer's place 20.

By using past data indicating a past gas consumption in a first predetermined period at the consumer's place 20, the remaining amount calculator 1 calculates a predicted value that represents the remaining gas amount of the gas container 11 after a second predetermined period has elapsed from a present time. Specifically, for example, in order to perform linear prediction, the remaining amount calculator 1 calculates the slope of the gas consumption by using the past data in the first predetermined period. In this case, the remaining amount calculator 1 may calculate the slope of the gas consumption by, for example, the method of least squares using the past data. The gas consumption after the second predetermined period has elapsed from the present time can be calculated based on the obtained slope. Then, the remaining amount calculator 1 converts the gas consumption that is the calculation result into the predicted value of the remaining gas amount. Specifically, the remaining amount calculator 1 obtains the predicted value of the remaining gas amount by subtracting the gas consumption that is the calculation result from the initial amount of gas. This predicted value is stored in the storage 4. Based on predetermined prediction frequency change trigger information, the remaining amount calculator 1 changes the frequency at which the predicted value of the remaining gas amount is calculated. Examples of a predetermined frequency include once every seven days, once every three days, and once a day. The prediction frequency change trigger information will be described later in detail.

The remaining amount calculator 1 may use a vaporization rate when calculating the remaining gas amount. In this case, the remaining amount calculator 1 calculates the remaining gas amount by using the vaporization rate corresponding to a location area of the consumer's place 20 corresponding to the gas meter 13 that transmits the measurement result or the vaporization rate corresponding to a date on which the measurement result is obtained by the gas meter 13.

The informer 2 controls a display, an audio device, or the like to inform of a warning. The informer 2 informs of a replacement timing of the gas container 11 based on the predicted value of the remaining gas amount calculated by the remaining amount calculator 1. Specifically, the informer 2 compares the predicted value of the remaining gas amount calculated by the remaining amount calculator 1 with a threshold. When the predicted value of the remaining gas amount is less than the threshold (hereinafter referred to as a “replacement threshold”), the informer 2 informs an operator, who replaces the gas container 11, of the warning that urges the operator to replace the gas container 11. A method of informing of this warning may be, for example, the distribution of a mail to the operator. After receiving the warning, the operator replaces the gas container 11 at the consumer's place 20. After the replacement, the operator notifies the center server 10 that the replacement has been completed. This notification from the operator is stored in the storage 4 together with a date.

The replacement threshold may be a value that is, for example, 10% of the volume of the gas container 11. However, the replacement threshold is not limited to this and may be a value that is, for example, more than 10% and 50% or less. In this case, when the remaining gas amount is less than the replacement threshold, the informer 2 determines that the replacement timing has been reached, and therefore, informs of the warning. When the remaining gas amount is the replacement threshold or more, the informer 2 determines that the replacement timing has not been reached, and therefore, does not inform of the warning. It should be noted that the above “10%” may be 10% of the total of the volumes of the gas containers 11 of each consumer's place 20 (i.e., the sum of the volumes of the gas containers 11 of each consumer's place 20) or may be 10% of the volume of any one of the gas containers 11. The above informing may be performed by a method of: creating a list of the consumer's places 20 in each of which the remaining gas amount is less than the replacement threshold; and transmitting this list to the operator once a day, for example.

The storage 4 stores the information of the gas use amount of the consumer's place 20, which has been received from the communicator 13a through the communicator 3, together with the date information regarding use or non-use (i.e., the use amount is zero), the ID that specifies the consumer's place 20, and the location area information of the consumer's place 20. Moreover, the storage 4 stores the replacement threshold, below-described various thresholds, the remaining gas amount calculated by the remaining amount calculator 1, and the like.

Hereinafter, the prediction frequency change trigger information will be described by using a plurality of specific examples.

### First Example

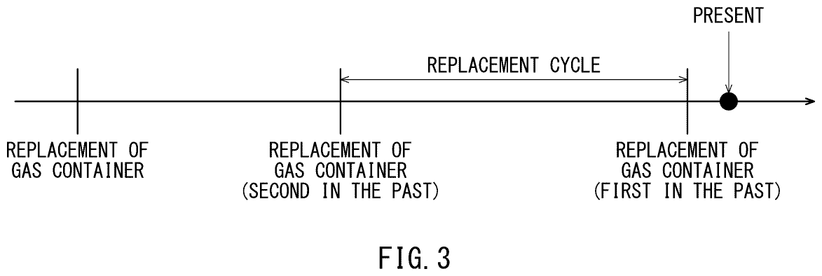

As the prediction frequency change trigger information, the remaining amount calculator 1 can use the replacement cycle of the gas container 11. FIG. 3 is a diagram for explaining the replacement cycle of the gas container 11. As shown in FIG. 3, the replacement cycle is, for example, the number of days between one of two most recent past gas container replacement dates and the other based on the present time. For example, when one of the gas container replacement dates is April 1, and the other is April 20, the replacement cycle is 19 days. The remaining amount calculator 1 reads the above notification of the operator from the storage 4 and calculates the replacement cycle of the gas container 11.

For example, until the number of days corresponding to half the replacement cycle or less elapses after the replacement of the gas container 11, the remaining amount calculator 1 can calculate the predicted value once every three days. When the number of days corresponding to more than half the replacement cycle elapses after the replacement, the remaining amount calculator 1 can calculate the predicted value once a day. Thus, based on the past actual value of the replacement cycle, the remaining amount calculator 1 may change the frequency at which the predicted value of the remaining gas amount is calculated.

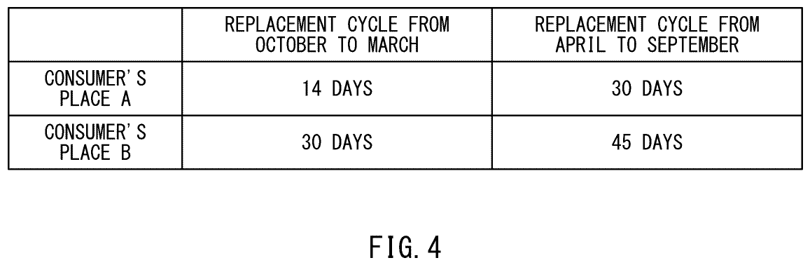

FIG. 4 is a diagram showing one example of the replacement cycles in respective seasons. In many cases, the gas consumption of each consumer's place 20 changes significantly depending on the season. Therefore, the replacement cycle of the gas container 11 may change depending on the season. For example, as shown in FIG. 4, in many cases, at each of a consumer's place A and a consumer's place B, the replacement cycle from April to September (the replacement cycle in a relatively hot period) is longer than the replacement cycle in October to March (the replacement cycle in a relatively cold period). Therefore, it is desirable that the remaining amount calculator 1 calculate the replacement cycles in the respective seasons instead of using the same replacement cycle throughout the year.

### Second Example

As the prediction frequency change trigger information, the remaining amount calculator 1 can use an elapsed time since the replacement of the gas container 11. In this case, the remaining amount calculator 1 reads the most recent replacement completion notification of the operator from the storage 4 and calculates an elapsed time from the date of the notification to the present time. For example, during a fixed period from immediately after the replacement, the remaining amount calculator 1 can calculate the predicted value once every three days. After the fixed period has elapsed, the remaining amount calculator 1 can calculate the predicted value once every two days. Thus, based on the elapsed time since the replacement of the gas container 11, the remaining amount calculator 1 may change the frequency at which the predicted value of the remaining gas amount is calculated.

### Third Example

As with First Example, the remaining amount calculator 1 can use the replacement cycle of the gas container 11 as the prediction frequency change trigger information. The remaining amount calculator 1 compares the replacement cycle of the gas container 11 with a first threshold. One example of the first threshold is seven days. The remaining amount calculator 1 calculates the predicted value of the remaining gas amount only for the consumer's place 20 whose replacement cycle is the first threshold or more. On the other hand, the remaining amount calculator 1 does not calculate the predicted value for the consumer's place 20 whose replacement cycle is less than the first threshold. To be specific, the remaining amount calculator 1 sets the number of times of the calculation of the predicted value to zero. This is based on the idea that, for the consumer's place 20 whose replacement cycle is, for example, less than seven days, it is sufficient to simply repeat the cycle of the replacement of the gas container 11 without predicting the remaining gas amount. As above, based on the past actual value of the replacement cycle, the remaining amount calculator 1 may change the frequency at which the predicted value of the remaining gas amount is calculated.

### Fourth Example

As the prediction frequency change trigger information, the remaining amount calculator 1 can use the remaining gas amount obtained from the gas consumption. Specifically, the remaining amount calculator 1 compares the remaining gas amount with a third threshold. When the remaining gas amount is the third threshold or more, the remaining amount calculator 1 sets the frequency at which the predicted value of the remaining gas amount is calculated, to be lower than the frequency set when the remaining gas amount is less than the third threshold. The third threshold is, for example, a numerical value corresponding to 50% of the volume of the gas container 11. In this case, when the remaining gas amount is 50% or more of the volume of the gas container 11, the remaining amount calculator 1 calculates the predicted value once every seven days. On the other hand, when the remaining gas amount is less than 50% of the volume of the gas container 11, the remaining amount calculator 1 can calculate the predicted value once every two days. As above, based on the present remaining gas amount, the remaining amount calculator 1 may change the frequency at which the predicted value of the future remaining gas amount is calculated.

### Fifth Example

Fifth Example is Modified Example of Fourth Example. Herein, the remaining amount calculator 1 calculates the predicted value of the remaining gas amount only when the remaining gas amount is less than a second threshold. On the other hand, when the remaining gas amount is the second threshold or more, the remaining amount calculator 1 does not calculate the predicted value of the remaining gas amount. To be specific, the remaining amount calculator 1 sets the number of times of the calculation of the predicted value to zero. As above, based on the present remaining gas amount, the remaining amount calculator 1 may change the frequency at which the predicted value of the future remaining gas amount is calculated.

### Sixth Example

As the prediction frequency change trigger information, the remaining amount calculator 1 can use the informing of the replacement timing of the gas container 11 by the informer 2. In this case, for example, before the informing is performed, the remaining amount calculator 1 can calculate the predicted value once every two days. After the informing is performed, the remaining amount calculator 1 can calculate the predicted value once a day. As above, based on the informing by the informer 2, the remaining amount calculator 1 may change the frequency at which the predicted value of the remaining gas amount is calculated.

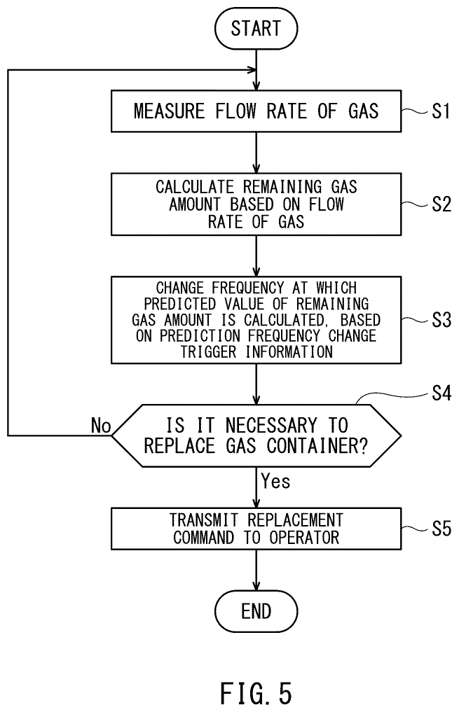

The overall processing of Embodiment 1 described above will be described using a flowchart. FIG. 5 is a flowchart showing one example of the flow of steps performed by the remaining gas amount management system 100 of Embodiment 1.

As shown in FIG. 5, in the remaining gas amount management system 100, first, the gas meter 13 measures, for example, the flow rate of the gas flowing to the gas appliance 14 from the gas container 11 located at the consumer's place 20 and converts the flow rate into the reference value indicating information regarding the use amount (consumption) of the gas (Step S1).

Next, the remaining amount calculator 1 receives the information regarding the use amount of the gas transmitted from the communicator 13a of the gas meter 13 in the consumer's place 20 through the communicator 3 and calculates the remaining gas amount based on the information regarding the use amount of the gas (Step S2). Then, when calculating the predicted value of the future remaining gas amount, the remaining amount calculator 1 changes the frequency of this calculation based on the above prediction frequency change trigger information (Step S3). As described above, Step S3 includes a case where the frequency at which the remaining amount calculator 1 calculates the predicted value is increased and a case where the number of times of the calculation is set to zero.

Next, the informer 2 compares the predicted value of the remaining gas amount calculated by the remaining amount calculator 1 with the replacement threshold (Step S4). When the predicted value of the remaining gas amount is less than the replacement threshold (Yes in Step S4), the informer 2 transmits a replacement command of the gas container 11 as the warning to the operator (Step S5). On the other hand, when the predicted value of the remaining gas amount is the replacement threshold or more (No in Step S4), the remaining amount calculator 1 returns to Step S1 and repeats Step SI and the subsequent steps. When the number of times of the calculation is set to zero in Step S3, whether or not the replacement of the gas container 11 is necessary can be determined in Step S4 based on the comparison between the present remaining gas amount calculated by the remaining amount calculator 1 and the replacement threshold.

As described above, according to the remaining gas amount management system 100 of the present embodiment, based on the predetermined prediction frequency change trigger information, the remaining amount calculator 1 changes the frequency at which the predicted value of the remaining gas amount is calculated. In this case, the remaining amount calculator 1 calculates the predicted value at a predetermined frequency during the fixed period and calculates the predicted value at a frequency higher than the predetermined frequency after the fixed period has elapsed. As above, although the predicted value is calculated at a high frequency after the fixed period has elapsed, the predicted value is not calculated at a high frequency before the fixed period elapses. Therefore, the load on the server can be reduced compared to before. Thus, the processing time can be prevented from increasing, and the necessity of increasing the specifications of the server can be reduced. Moreover, especially when performing the prediction using machine learning, the creation of input processing information for learning and the creation of a prediction model require enormous cost and processing time. However, according to the remaining gas amount management system 100 of the present embodiment, the cost and the processing time can be reduced. Thus, the cost and the processing time when predicting the remaining gas amount in the consumer's place 20 can be suppressed.

### Embodiment 2

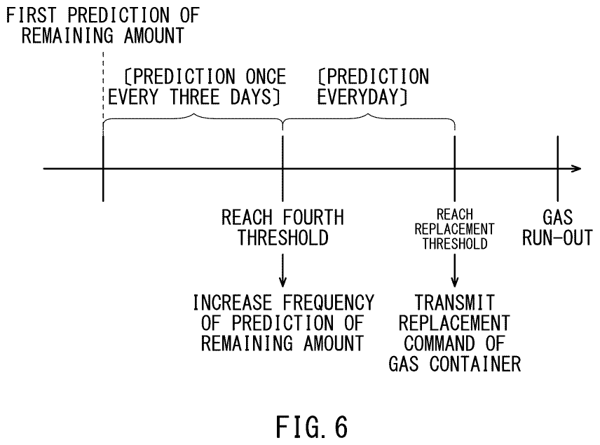

The prediction frequency change trigger information in Embodiment 2 will be described by using a plurality of specific examples. Unlike Embodiment 1, in Embodiment 2, the predicted value of the remaining gas amount is calculated once before changing the frequency at which the predicted value of the remaining gas amount is calculated. FIG. 6 is a diagram showing a time series regarding the management of the remaining gas amount of the consumer's place 20 in Embodiment 2.

### Seventh Example

As shown in FIG. 6, the remaining amount calculator 1 calculates the predicted value that represents the remaining gas amount after the second predetermined period has elapsed (for example, after seven days have elapsed) from the present time. Then, the remaining amount calculator 1 uses the obtained predicted value as the prediction frequency change trigger information and compares the predicted value with a fourth threshold. In a period in which the predicted value is the fourth threshold or more as a result of the comparison, the remaining amount calculator 1 calculates the predicted value, for example, once every three days. On the other hand, in a period in which the predicted value is less than the fourth threshold, the remaining amount calculator 1 calculates the predicted value, for example, once a day to increase the frequency of the prediction, and in addition, the informer 2 compares the obtained predicted value with the replacement threshold. When the predicted value is less than the replacement threshold as a result of the comparison, the informer 2 informs the operator of the warning. As above, the remaining amount calculator 1 may change the frequency at which the predicted value of the remaining gas amount is calculated.

### Eighth Example

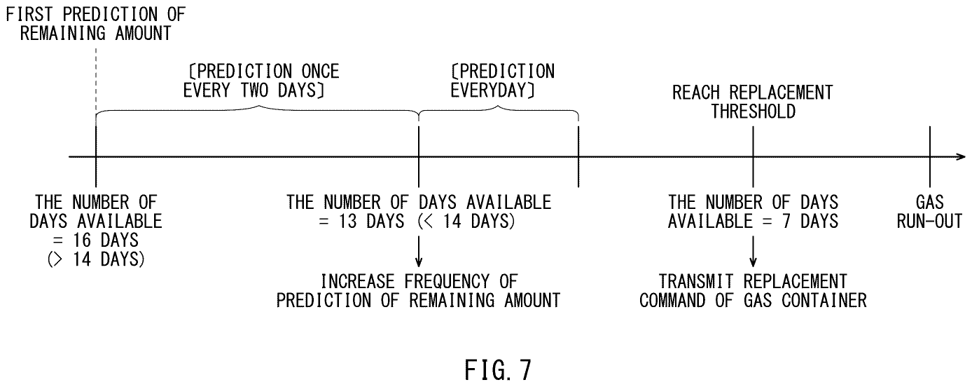

FIG. 7 is a diagram showing a time series regarding the management of the remaining gas amount according to Modified Example of FIG. 6. Unlike Seventh Example in which the predicted value of the remaining gas amount is used as the prediction frequency change trigger information, in Eighth Example, the number of days available until the replacement timing of the gas container 11 which may be calculated based on the predicted value of the remaining gas amount is used as the prediction frequency change trigger information.

In FIG. 7, as with FIG. 6, the remaining amount calculator 1 calculates the predicted value that represents the remaining gas amount after the second predetermined period has elapsed (for example, after seven days have elapsed) from the present time. Then, based on the obtained predicted value and the replacement threshold, the remaining amount calculator 1 calculates the number of days available until the replacement timing of the gas container 11.

For example, when the obtained predicted value of the remaining gas amount (the predicted value after seven days have elapsed) is 1.5 m³, and the replacement threshold is 1 m³ , the remaining amount calculator 1 performs the linear prediction and obtains, for example, ten days as the number of days available.

The remaining amount calculator 1 compares the obtained number of days available with a fifth threshold (14 days, for example). In a period in which the number of days available is the fifth threshold or more as a result of the comparison, the remaining amount calculator 1 calculates the predicted value, for example, once every two days. On the other hand, in a period in which the number of days available is less than the fifth threshold, the remaining amount calculator 1 calculates the predicted value, for example, once a day to increase the frequency of the prediction, and in addition, the informer 2 compares the number of days available with the replacement threshold (a value obtained by converting a value corresponding to, for example, 10% of the volume of the gas container 11 into the number of days; for example, seven days). When the number of days available is less than the replacement threshold as a result of the comparison, the informer 2 informs the operator of the warning. As above, the remaining amount calculator 1 may change the frequency at which the predicted value of the remaining gas amount is calculated.

### Ninth Example

In Ninth Example, first, the remaining amount calculator 1 calculates the present remaining gas amount. Then, as with Seventh Example, the remaining amount calculator 1 calculates the predicted value that represents the remaining gas amount after the second predetermined period has elapsed (for example, seven days have elapsed) from the present time. Moreover, based on the present remaining gas amount and the predicted value of the remaining gas amount, the remaining amount calculator 1 calculates a consumable amount that is the amount of gas usable per day until the second predetermined period elapses. For example, when the present remaining gas amount is 3 m³, and the predicted value of the remaining gas amount after seven days have elapsed is 1.5 m³, the consumable amount that is the amount of gas usable per day is 0.21429 m³.

The remaining amount calculator 1 uses, as the prediction frequency change trigger information, the gas consumption of the consumer's place 20 on or after the day following the day on which the consumable amount is calculated, and compares this gas consumption with the consumable amount. When the gas consumption of the consumer's place 20 exceeds the consumable amount as a result of the comparison, the remaining amount calculator 1 calculates the predicted value of the remaining gas amount. On the other hand, when the gas consumption of the consumer's place 20 is the consumable amount or less, the remaining amount calculator 1 does not calculate the predicted value of the remaining gas amount. To be specific, the remaining amount calculator 1 sets the number of times of the calculation of the predicted value to zero. As above, the remaining amount calculator 1 may change the frequency at which the predicted value of the remaining gas amount is calculated.

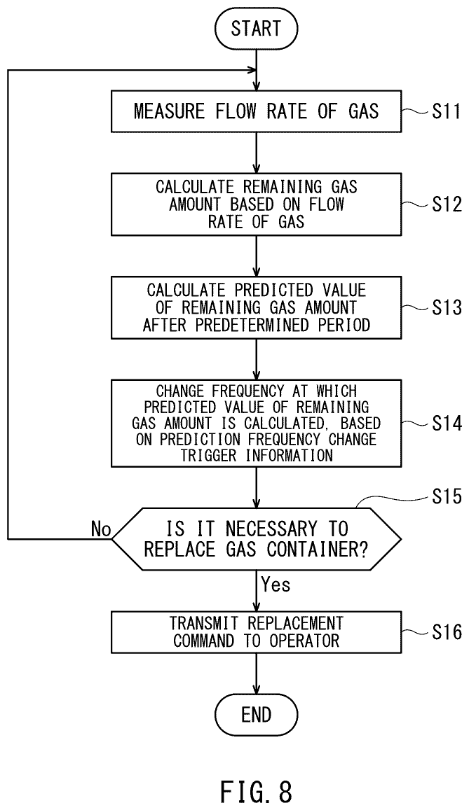

The overall processing of Embodiment 2 described above will be described using a flowchart. FIG. 8 is a flowchart showing one example of the flow of steps performed by the remaining gas amount management system 100 of Embodiment 2.

As shown in FIG. 8, in the remaining gas amount management system 100, first, the gas meter 13 measures, for example, the flow rate of the gas flowing to the gas appliance 14 from the gas container 11 located at the consumer's place 20 and converts the flow rate into the reference value indicating the information regarding the use amount (consumption) of the gas (Step S11).

Next, the remaining amount calculator 1 receives the information regarding the use amount of the gas transmitted from the communicator 13a of the gas meter 13 in the consumer's place 20 through the communicator 3 and calculates the remaining gas amount based on the information regarding the use amount of the gas (Step S12). Then, the remaining amount calculator 1 calculates the predicted value that represents the remaining gas amount after the second predetermined period has elapsed from the present time (Step S13).

Next, based on the above prediction frequency change trigger information, the remaining amount calculator 1 changes the frequency at which the predicted value of the remaining gas amount is calculated (Step S14). As described above, Step S14 includes a case where the frequency at which the remaining amount calculator 1 calculates the predicted value is increased and a case where the number of times of the calculation is set to zero.

Next, the informer 2 compares the predicted value of the remaining gas amount calculated by the remaining amount calculator 1 with the replacement threshold (Step S15). When the predicted value of the remaining gas amount is less than the replacement threshold (Yes in Step S15), the informer 2 transmits the replacement command of the gas container 11 as the warning to the operator (Step S16). On the other hand, when the predicted value of the remaining gas amount is the replacement threshold or more (No in Step S15), the remaining amount calculator 1 returns to Step S11 and repeats Step S11 and the subsequent steps. When the number of times of the calculation is set to zero in Step S14, whether or not the replacement of the gas container 11 is necessary can be determined in Step S15 based on the comparison between the present remaining gas amount calculated by the remaining amount calculator 1 and the replacement threshold.

As described above, also in Embodiment 2, based on the prediction frequency change trigger information, the remaining amount calculator 1 changes the frequency at which the predicted value of the remaining gas amount is calculated. Therefore, as with Embodiment 1 described above, the load on the server can be reduced compared to before. Thus, the processing time can be prevented from increasing, and the necessity of increasing the specifications of the server can be reduced. Moreover, especially when performing the prediction using machine learning, the creation of input processing information for learning and the creation of a prediction model require enormous cost and processing time. However, the cost and the processing time can be reduced also in Embodiment 2. Thus, the cost and the processing time when predicting the remaining gas amount in the consumer's place 20 can be suppressed.

### Modified Example

The present invention is not limited to the above embodiments, and various modifications may be made within the scope of the present invention. Examples are as below.

In the above embodiments, the informer 2 informs of the replacement timing of the gas container 11. However, the above embodiments are not limited to this. The informer 2 may inform of the predicted value of the remaining gas amount or may inform of, for example, the replacement cycle of the gas container 11.

Moreover, in the above embodiments, for example, an ultrasonic meter can be adopted as the gas meter 13. However, the above embodiments are not limited to this. For example, a diaphragm meter using a metering diaphragm may be adopted as the gas meter 13.

Moreover, in the above embodiments, the predicted value of the remaining gas amount is calculated by the linear prediction performed by the remaining amount calculator 1. However, the above embodiments are not limited to this. The predicted value of the remaining gas amount may be calculated by machine learning based on artificial intelligence.

Moreover, the above embodiments have described that it is desirable that the replacement cycles be calculated in the respective seasons instead of using the same replacement cycle throughout the year. However, the above embodiments are not limited to this. In order to make the replacement cycles more precise, the replacement cycles may be calculated, for example, in the respective months.

Moreover, in the above embodiments, the remaining gas amount management system 100 is described as a technical concept including the gas meter 13 and the center server 10. However, the above embodiments are not limited to this. The remaining gas amount management system 100 may be a system provided at the gas meter 13.

Moreover, in the above embodiments, the remaining amount calculator 1 and the informer 2 are located at the center server 10. However, the above embodiments are not limited to this. The remaining amount calculator 1 and the informer 2 may be located at the gas meter 13, and the center server 10 may have a function of outputting informing contents.

Moreover, the above embodiments have described an example in which each consumer's place 20 includes two gas containers 11 and two gas appliances 14. However, the above embodiments are not limited to this. The number of gas containers 11 may be one or may be three or more, and the number of gas appliances 14 may be one or may be three or more.

Furthermore, in the above embodiments, the gas container 11 is filled with the LP gas (liquefied petroleum gas) as one example of the gas. However, the above embodiments are not limited to this. The gas container 11 may be filled with another gas, such as oxygen.

### REFERENCE SIGNS LIST

1 remaining amount calculator
2 informer
3 communicator
4 storage
10 center server
11 gas container
13 gas meter
13a communicator
14 gas appliance
20 consumer's place
100 remaining gas amount management system

1. A remaining gas amount management system comprising:
a flow rate measurer that measures a flow rate of a gas flowing to a gas appliance from a gas container located at a consumer's place or at each of a plurality of consumer's places;
a remaining amount calculator that calculates a predicted value by using past data indicating past gas consumption in a first predetermined period, the predicted value representing a remaining gas amount of the gas container after a second predetermined period has elapsed; and
an informer that informs of a replacement timing of the gas container based on the predicted value or a replacement cycle of the gas container, wherein
based on predetermined prediction frequency change trigger information, the remaining amount calculator changes a frequency at which the predicted value is calculated.

2. The remaining gas amount management system according to claim 1, wherein the remaining amount calculator changes the frequency based on a past actual value of the replacement cycle as the prediction frequency change trigger information.

3. The remaining gas amount management system according to claim 1, wherein the remaining amount calculator changes the frequency based on an elapsed time since the replacement of the gas container, as the prediction frequency change trigger information.

4. The remaining gas amount management system according to claim 1, wherein:
when the replacement cycle as the prediction frequency change trigger information is a first threshold or more, the remaining amount calculator calculates the predicted value; and
when the replacement cycle is less than the first threshold, the remaining amount calculator does not calculate the predicted value.

5. The remaining gas amount management system according to claim 1, wherein the remaining amount calculator changes the frequency based on the remaining gas amount obtained from the gas consumption, as the prediction frequency change trigger information.

6. The remaining gas amount management system according to claim 5, wherein when the remaining gas amount is less than a second threshold, the remaining amount calculator calculates the predicted value.

7. The remaining gas amount management system according to claim 5, wherein when the remaining gas amount is a third threshold or more, the remaining amount calculator sets the frequency to be lower than the frequency set when the remaining gas amount is less than the third threshold.

8. The remaining gas amount management system according to claim 1, wherein the remaining amount calculator changes the frequency based on informing performed by the informer, as the prediction frequency change trigger information.

9. The remaining gas amount management system according to claim 1, wherein:
after the remaining amount calculator calculates the predicted value, the remaining amount calculator compares the predicted value as the prediction frequency change trigger information with a fourth threshold; and
when the predicted value is the fourth threshold or more, the remaining amount calculator sets the frequency to be lower than the frequency set when the predicted value is less than the fourth threshold.

10. The remaining gas amount management system according to claim 1, wherein:
after the remaining amount calculator calculates the predicted value, the remaining amount calculator calculates, based on the predicted value, the number of days available until a replacement timing of the gas container;
the remaining amount calculator compares the number of days available as the prediction frequency change trigger information with a fifth threshold; and
when the number of days available is the fifth threshold or more, the remaining amount calculator sets the frequency to be lower than the frequency set when the number of days available is less than the fifth threshold.

11. The remaining gas amount management system according to claim 1, wherein:
after the remaining amount calculator calculates the predicted value, the remaining amount calculator calculates a consumable amount based on a present remaining gas amount and the predicted value, the consumable amount being an amount of gas usable per day until the second predetermined period elapses;
the remaining amount calculator compares the gas consumption on or after the day following the day on which the consumable amount as the prediction frequency change trigger information is calculated, with the consumable amount;
when the gas consumption exceeds the consumable amount, the remaining amount calculator calculates the predicted value; and
when the gas consumption is the consumable amount or less, the remaining amount calculator does not calculate the predicted value.
